(19) United States
(12) Patent Application Publication
(10) Pub. No.: US 2006/0103872 A1
(43) Pub. Date: May 18, 2006

(54) Electronic document management program and electronic document management apparatus

(75) Inventor: Nobuhiro Shimogori, Kawasaki-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/991,624

(22) Filed: Nov. 17, 2004

(51) Int. Cl. G06F 3/12

(52) U.S. Cl. 358/1.15

(57) ABSTRACT

An electronic document management apparatus is provided in which there is no need to convert an electronic document into a bitmapped print image when a request is made for outputting the electronic document. In an electronic document management apparatus 10 of the present invention, an update detection part 401 detects newly created or updated electronic documents from among electronic documents stored in a document storage part 411. A document management part 402 stores management information of files containing therein electronic documents in a management information storage part 412, and manages the document files. Bitmapped print images for the newly created or updated electronic documents are rendered by a print image rendering part 404, and stored in an image storage part 405 in association with the management information. When an output instruction for an electronic document is given to a print instruction part 407, a print management part 408 makes a corresponding print image output from the image storage part, so there is no need to wait for conversion of the document into a print image at the time of output thereof.

### BACKGROUND OF THE INVENTION

1. Field of the Invention

The present invention relates to an electronic document management program and apparatus, and more specifically, to an electronic document management program and apparatus capable of immediately providing print images for printing, displaying or the like to a higher level apparatus on which an electronic document management apparatus is installed.

2. Description of the Related Art

Printing devices widely used in today's offices, etc., converts images to be printed into bitmap print images having an accuracy of 600 dpi. Though the processing speeds of the printing devices are enhanced year by year due to improvements such as those of semiconductors, a lot of processing or turnaround time is still required to draw a lot of dots as stated above The print image of a document is of a type suitable for a person to make use of the document and hence may be used for use of the document, but requires a lot of processing time as referred to above, so in general, other application programs of better processing efficiency are used.

In addition, there have also been disclosed a print processing system and a print processing method in which even under environments where the above-mentioned application programs do not exist, print processing can be performed on a server with applications existing thereon through a network (Japanese patent application laid-open No. 2000-284927). Further, there often occur situations in businesses where computers (e.g., PCs), being in a waiting state (power-on state), are left unattended for some reasons such as the users attending to meetings, etc. In this connection, it is known that this idle state is considerably long, and experiments have also been conducted that collects the time of such an idle state from each computer and performs parallel processing (e.g., http://setiathome.ssl.berkeley.edu/).

However, there arises the following problem. That is, when documents are printed in the above-mentioned prior art, the server for conversion of the documents is required other than the computers that the users daily use, and such conversion of the documents by the server is implemented at the time when the print images thereof become necessary, so users precious time is wasted while waiting for the completion of the conversion.

### SUMMARY OF THE INVENTION

The present invention is intended to obviate the problem as referred to above, and has for its object to provide an electronic document management apparatus which is capable of detecting newly created or updated ones from among stored electronic documents, and rendering in advance bitmapped print images of the electronic documents thus detected, so that a necessary print image can be immediately provided without awaiting conversion processing thereof when the print image become necessary for printing or the like, and which is also capable of performing these processing operations by making use of a higher level machine during time periods in which a user is not using the machine or its computing function for improved use efficiency thereof.

In order to solve the above-mentioned problem, an electronic document management program according to the present invention comprises: a step of converting in advance electronic documents into bitmapped print images and storing them prior to the occurrence of an output request for the electronic documents; and a step of outputting, upon an electronic document being requested to be output, that one of the converted and stored print images which corresponds to the electronic document thus requested.

With such a configuration, the electronic document management program according to the present invention converts in advance electronic documents into bitmapped print images prior to the occurrence of an output request for the electronic documents and stores the print images thus obtained, so that when an electronic document is requested to be output, a previously converted and stored corresponding print image can be output. As a consequence, upon the output request for the electronic document, there is no need for conversion thereof into the corresponding print image, thus making it possible to immediately respond to such a request.

In addition, the present invention also resides in an electronic document management program comprising: a step of storing electronic documents from a higher order device; a step of storing data for recognition, from which the stored electronic documents and their features can be recognized, respectively; a step of detecting newly created or updated electronic documents that have not been subjected to bitmap conversion processing after storage thereof from among the stored electronic documents at each electronic document processing timing; a step of rendering bitmapped print images for the newly created or updated electronic documents thus detected, and storing the print images thus rendered in association with the data for recognition of the electronic documents; and a step of selecting and outputting, when an output request for an electronic document is made based on the data for recognition, a print image corresponding to the requested electronic document from among the print images stored.

Moreover, an electronic document management apparatus according to the present invention comprises: a document storage part that stores electronic documents from a higher order device; an update detection part that detects newly created or updated electronic documents which have not been subjected to bitmap conversion processing after storage thereof from among the electronic documents stored in the document storage part at each electronic document processing timing; a print image rendering part that converts the electronic documents into bitmapped print images; an image storage part; a document management part that manages data for recognition, from which the electronic documents stored in the document storage part and their features can be recognized, respectively, makes, upon detection of the newly created or updated electronic documents by the update detection part, the print image rendering part render print images of the electronic documents thus detected, and stores the print images thus rendered in the image storage part in association with the data for recognition of the electronic documents detected by the update detection part; and a print image output part that reads and outputs, upon occurrence of an output request for an electronic document based on the data for recognition, a print image corresponding to the data for recognition of the electronic document requested to be output from the image storage part.

### BRIEF DESCRIPTION OF THE DRAWINGS

FIG. 1 is a block diagram showing a first embodiment of an electronic document management apparatus according to the present invention.

FIG. 2 is a flow chart for explaining an operation, from the rendering to storage of a print image, of the electronic document management apparatus of FIG. 1.

FIG. 3 is a view illustrating management information for document files registered in a management information storage part shown in FIG. 1.

FIG. 4 is a flow chart for explaining an operation of the electronic document management apparatus of FIG. 1 to process a print instruction.

FIG. 5 is a block diagram showing a second embodiment of the electronic document management apparatus of the present invention.

FIG. 6 is a block diagram illustrating mobile equipment for receiving print images sent by the electronic document management apparatus of FIG. 5.

FIG. 7 is a block diagram showing a third embodiment of the electronic document management apparatus of the present invention.

FIG. 8 is a flow chart for explaining the overall flow of processing in the document management apparatus according to this embodiment.

### DESCRIPTION OF THE EMBODIMENTS

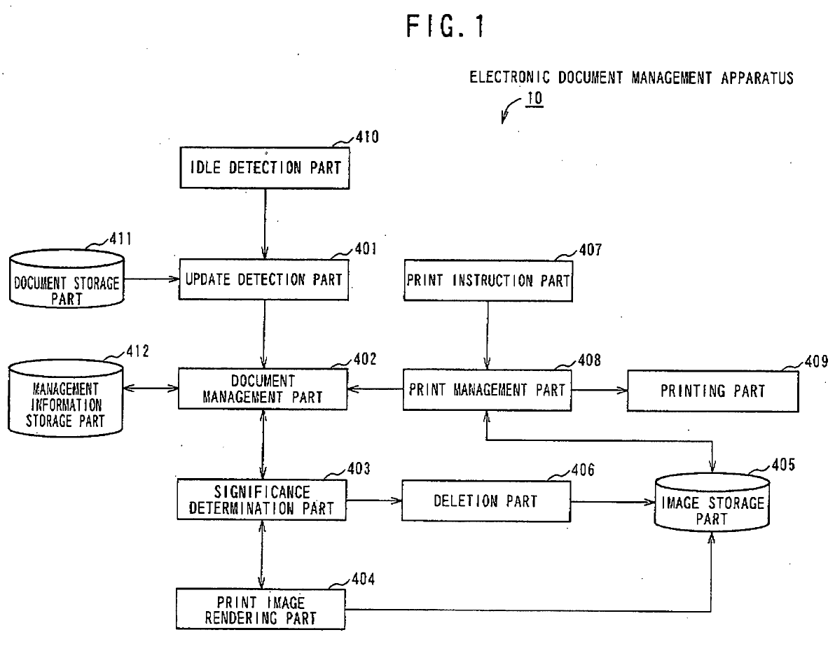

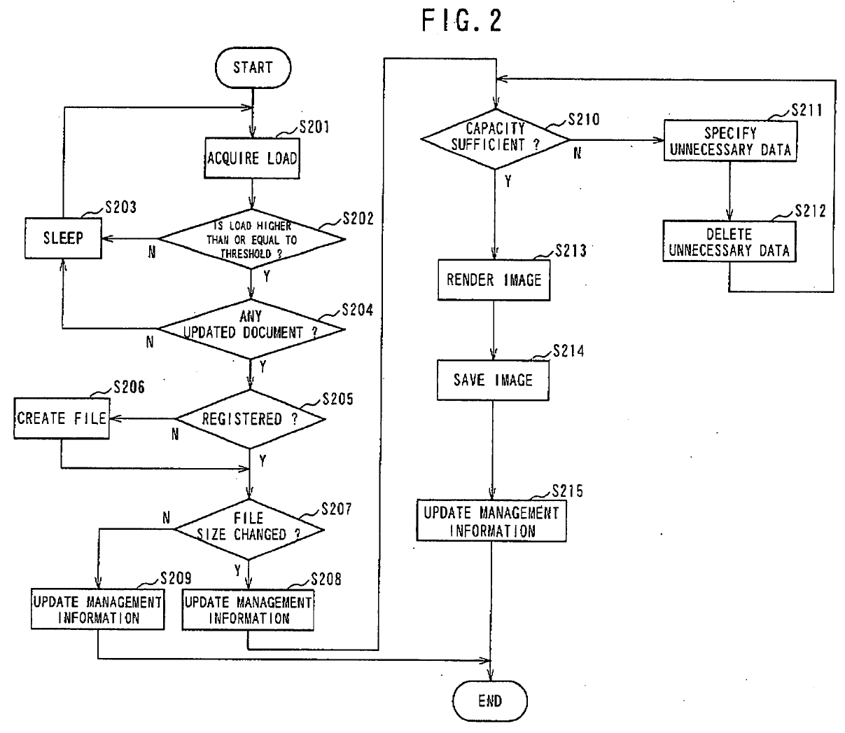

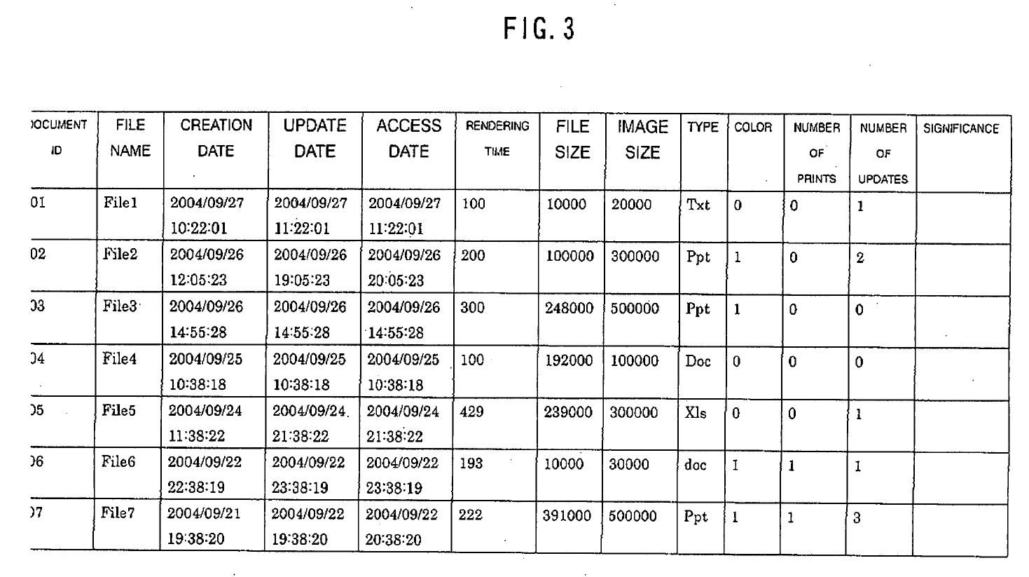

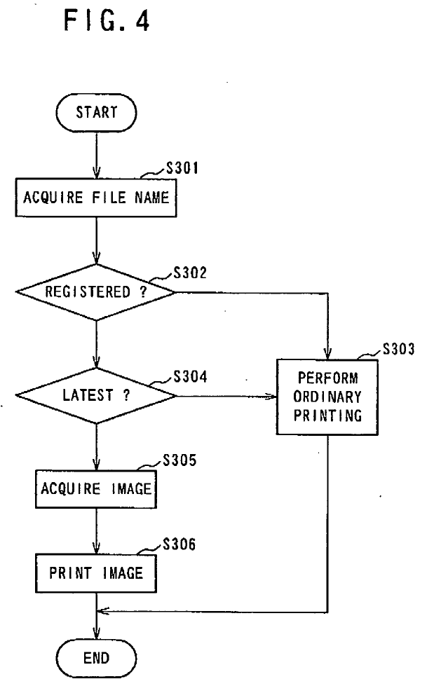

Hereinafter, preferred embodiments of the present invention will be described in detail while referring to the accompanying drawings. FIG. 1 is a block diagram that shows a first embodiment of an electronic document management apparatus according to the present invention. FIG. 2 is a flow chart that illustrates an operation, from the rendering to storage of print images, of the electronic document management apparatus of FIG. 1. FIG. 3 is a view that illustrates management information for document files registered in a management information storage part shown in FIG. 1. FIG. 4 is a flow chart that illustrates an operation of the electronic document management apparatus of FIG. 1 to process a print instruction. The electronic document management apparatus 10 in FIG. 1 includes an update detection part 401, a document management part 402, a significance determination part 403, a print image rendering part 404, an image storage part 405, a deletion part 406, a print instruction part 407, a print management part 408, a printing part 409, an idle detection part 410, a document storage part 411, a management information storage part 412, an unillustrated control section, and an unillustrated storage section.

In the electronic document management apparatus 10 in FIG. 1, the idle detection part 410 monitors the operation of a higher order device (e.g., multi-function printer), acquires a load in the operation (S201), and determines whether the load is higher than or equal to a prescribed threshold (S202). When the load is higher than or equal to the threshold, the apparatus is slept for a predetermined time (S203), and then a return to step S201 is carried out, whereas when it is determined in step S202 that the load is lower than the threshold, such a determination is notified to the update detection part 401 as an idle state.

The update detection part 401 having received the notification of the idle state checks document files in the form of files that are stored in the document storage part 411 and contain therein electronic documents (hereinafter usually referred to as documents), and determines whether there is any document file therein that has been newly created or updated (S204). When it is determined that there is no document file newly created or updated, a return to step S203 is performed, whereas when it is determined that there is a document file newly created or updated, the file name of the document file thus detected is notified to the document management part 402. The document management part 402 determines whether the management information of the document file thus notified has been registered in the management information storage part 412 (S205). When registered, no action is needed, whereas when not registered, the file notified is newly registered in the management information storage part 412 (S206). Though the management information of the document file registered in the management information storage part 412 in this example will be described later, it may be the one as illustrated in FIG. 3, for example.

The document management part 402, after the processing in step S205 or S206, determines whether the file size of the document file being processed has been changed (S207). When the file size has not been changed, only the date of update of the file is changed to a current value (S209), and the control flow is terminated, whereas when the file size has been changed, the file size and the date of update of the file are changed to current values. The processing state is regarded as under processing (S208), and the processing, if finished, is regarded as having been completed. Here, note that as a method of verifying whether a file has been updated or not, there is a method of determining whether files are identical with one another, by using a hash function such as MD5 with respect to the contents of the files, besides the method of checking a change in the file size as referred to above. After step S208, the document management part 402 takes out or acquires information on the time required to render a print image of the document of the file concerned, the size thereof and the like from the management information storage part 412, and notifies it to the significance determination part 403.

The significance determination part 403 determines the level of significance (or also referred to simply as significance) of the newly created or updated document such as the possibility thereof being printed by using the information received from the document management part 402, etc. Here, one example of such a determination of the significance will be described. In this example, the significance VP is calculated according to the following expression (1).
significance VP=Fm (current time−date and time of update)
+Fr (rendering time)
+Ft (value of type)
+Fc (color)
+Fp (number of prints)
+Fe (number of updates) (1)

In expression (1) above, Fm is a function that depends on the time elapsed from the last update of the file, with its returned value decreasing in accordance with the passage of time. Here, as an example, Fm (t)=a/t (a is a constant of 1000) is used. Fr is a function in which its input is the time required for the image rendering part to render the print image, with its returned value increasing in accordance with the increasing rendering time, and Fr (t)=bt (b is a constant of 10) is used as an example. Ft is a function whose returned value changes depending on the type of the file, which is decided by the data format and the method of acquisition of the file. For example, in Windows (registered trademark) of Microsoft (registered trademark) Corporation, the type of a file can be determined by the extension thereof in the following manner. For example, if a file has an extension of txt, the file is a text file, and if jpg, the file is an image file of a JPEG format, and so on. Besides, there are files that have, other than an extension, a code to identify their format embedded in the head portion of each file, as in the case of a PDF format, and in this case, the type of such a file can be determined by this code.

The returned values according to the types of files as stated above can be set as shown in Table (1) below.

TABLE 1

| Type | Returned Value |
|---|---|
| ppt | 20 |
| xls | 10 |
| doc | 15 |
| txt | 5 |
| scan | 0 |
| pdf | 15 |
| unknown | 0 |

Of course, the above-mentioned returned values may be changed in accordance with settings to individual users. In addition, if a print image is black and white, Fc in expression (1) above returns 0, and if color, it returns a constant (e.g., 100). Fp is a function that has a value increasing in accordance with the number of prints (x). and Fp(x)=dx (d is a constant of 100) is used. Fe is a function that has a value increasing in accordance with the number of edits (y), and for example, Fe (y)=ey (e is a constant of 100) is used.

Further, the significance determination part 403 verifies the capacity of the image storage part 405 so as to determine whether there is room for addition of new writing (S210) When there is no room, print images are specified as unnecessary data in the order of lowest to highest significance (S211), so that the unnecessary data thus specified is deleted in advance from the image storage part 405 by using the deletion part 406 (S212). In this case, for example, old and large print images, for which processing for bitmap conversion has been completed, will correspond to the data of low significance. These steps S210, S211 and S212 are repeated until room to newly add writing is generated.

When it is determined in step S210 that there is room to newly add writing, the print image rendering part 404 may render the print images of all the electronic documents, but in this example, it is preferable that bitmapped print images be rendered for those documents whose levels of significance being higher than or equal to a predetermined threshold have been determined to be significant (S213), and be stored and saved in the image storage part 405 (S214). When the saving has been completed, the rendering of the images is regarded as completed, so that the sizes of the print images thus rendered are written into the corresponding management information stored in the management information storage part 412, thereby updating the management information in the management information storage part 412 (S215).

Next, reference will be made to the operation of the electronic document management apparatus when a print instruction is input thereto through the print instruction part while referring to FIG. 4. When a print instruction with a document indicated or designated by a file name is input through the print instruction part 407, the print management part 408 acquires the file name thus input (S301). The print management part 408 determines whether the acquired file name has been registered in the management information storage part 412 (S302). When it is determined that the file name has not yet been registered, ordinary print processing similar to the conventional one is carried out (S303).

When it is determined in step S302 that the file name has already been registered, information on the document to be printed is acquired from the document management part 402, and it is determined whether the document to be printed is identical with the content registered in the document management part 402. For example, a comparison is made between the last updated date of the file registered In the management information storage part 412 and the current last updated date of the file instructed from the print instruction part 407. When they are different from each other as a result of the comparison, the control flow proceeds to step S303 where the ordinary print processing is carried out. When they are identical with each other in step S304, a corresponding print image is acquired from the image storage part 405 (S305), and delivered to the printing part 409 where the print image thus delivered is printed (S306). In this case, since the print image thus delivered to the printing part 409 has already been converted into a bitmap image, the printing part 409 can perform printing quickly without requiring a conversion time.

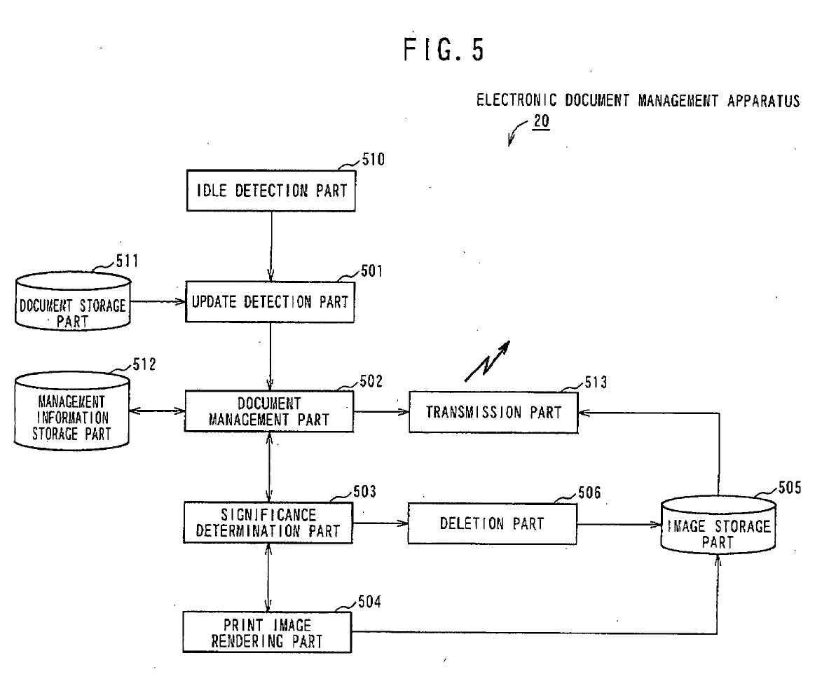

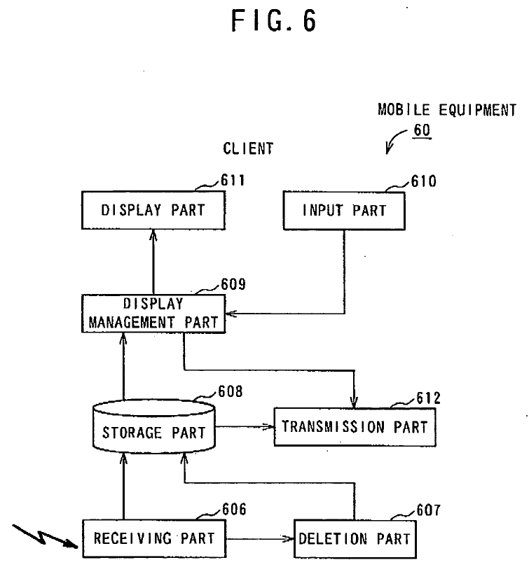

FIG. 5 is a block diagram that illustrates a second embodiment of the electronic document management apparatus of the present invention. FIG. 6 is a block diagram that illustrates mobile equipment to which the electronic document management apparatus of FIG. 5 provides services. The electronic document management apparatus 20 illustrated in FIG. 5 is provided with a transmission part 513 instead of the print instruction part 407, the print management part 408 and the printing part 409 of the electronic document management apparatus 10 of FIG. 1. Accordingly, the electronic document management apparatus 20 includes an update detection part 501, a document management part 502, a significance determination part 503, a print image rendering part 504, an image storage part 505, a deletion part 506, an idle detection part 510, a document storage part 511, a management information storage part 512, and the transmission part 513.

The operations of the respective parts 501-513 of the electronic document management apparatus 20 of FIG. 5 are the same as those of the respective parts 401-412 of the electronic document management apparatus 10 of FIG. 1 except for the operation of the transmission part 513, and hence an explanation thereof is omitted. The transmission part 513 transmits the print image of an electronic document rendered by the image rendering part to a client (e.g., mobile equipment). In this case, it is preferable that the transmission part 513 transmit the print image to the client at timing at which an idle state of the client is detected by the idle detection part 510.

In mobile equipment 60 of FIG. 6, a receiving part 606 receives a transmission signal sent from the transmission part 513 of the electronic document management apparatus 20 of FIG. 5, extracts the print image therefrom and stores it in a storage part 608. In this case, the document management part 502 (FIG. 5) calculates, based on the amount of data thus transmitted, whether the storage capacity left in the storage part 608 is insufficient. When the storage capacity is insufficient, insignificant documents are sequentially indicated by the significance determination part 503 until a necessary storage capacity can be obtained. The document management part 502 sends to the receiving part 606 through the transmission part 513 an instruction to delete the insignificant documents thus indicated in the order of insignificance.

The receiving part 606, having received the deletion instruction as stated above, delivers the deletion instruction to a deletion part 607, which then deletes the indicated or designated print images from the storage part 608. When requested to display a document through an input part 610, a display management part 609 reads the print image of the document to be displayed from the storage part 608, and makes them displayed on a display part 611. When a document print or projection instruction is received through the input part 610, the display management part 609 reads the print image of the corresponding document from the storage part 608, and delivers it to a transmission part 612 for transmission thereof. The transmission part 612 transmits the print image thus received to unillustrated printing equipment or projection equipment, so that printing or projection thereof is carried out.

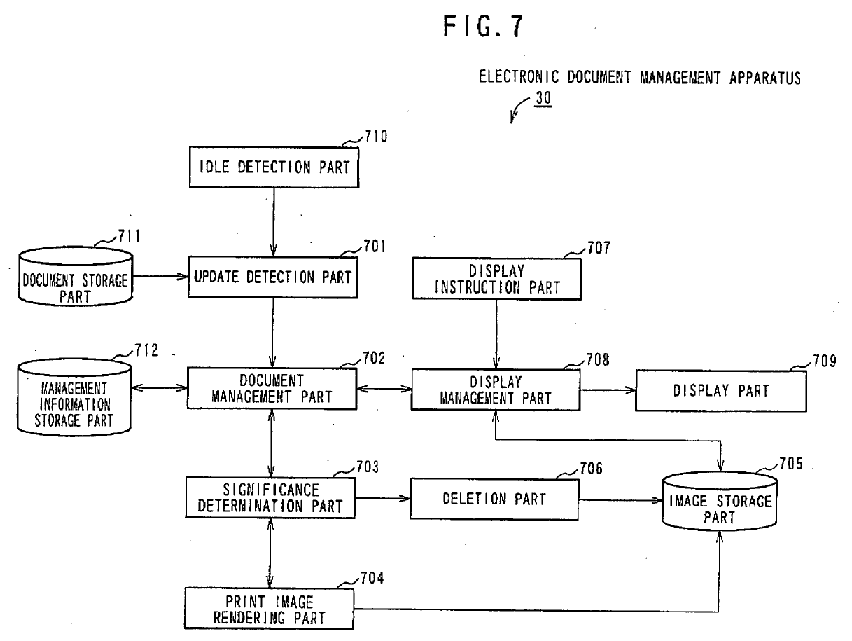

FIG. 7 is a block diagram that illustrates a third embodiment of the electronic document management apparatus of the present invention. The electronic document management apparatus 30 of FIG. 7 includes an update detection part 701, a document management part 702, a significance determination part 703, a print image rendering part 704, an image storage part 705, a deletion part 706, a display instruction part 707, a display management part 708, a display part 709, an idle detection part 710, a document storage part 711, and a management information storage part 712. Accordingly, the electronic document management apparatus 30 of FIG. 7 employs a construction similar to that of the electronic document management apparatus 10 of FIG. 1 except that the print instruction part 407, the print management part 408, and the printing part 409 of FIG. 1 are replaced by the display instruction part 707, the display management part 708, and the display part 709, respectively.

Since the electronic document management apparatus 30 of FIG. 7 is different only partially from the electronic document management apparatus 10 of FIG. 1, the different parts alone will be described. That is, reference will be made to the operation of the electronic document management apparatus when an electronic document display instruction is input to the electronic document management apparatus 30 of FIG. 7 through the display instruction part. When a display instruction with a document indicated or designated by its file name is input through the display instruction part 707, the display management part 708 determines whether the file name acquired has been registered in the management information storage part 712, and when it is determined that the file name has not been registered, ordinary display processing similar to conventional one is performed.

When it is determined that the file name has already been registered, information on the document to be displayed is acquired from the document management part 702, and it is determined whether the document to be displayed is identical with the content thereof registered in the document management part 702. For example, a comparison is made between the last updated date of the file registered in the management information storage part 712 and the current last updated date of the file instructed from the display instruction part 707. When they are different from each other as a result of the comparison, the ordinary display processing is carried out, whereas when they are identical with each other, a corresponding print image is acquired from the image storage part 705, and delivered to the display part 709 where the print image thus delivered is displayed. In this case, since the print image thus delivered to the display part 709 has already been converted into a bitmap image, the display part 709 can perform displaying quickly without requiring a conversion time.

In the electronic document management apparatuses 10. 20 and 30 of FIG. 1, FIG. 5 and FIG. 7, respectively, the document storage part, the management information storage part, and the image storage part are illustrated as separate parts, but it is needless to say that these parts can be set in properly partitioned or divided storage areas of the same storage medium (e.g., the image storage part if its capacity has enough room therefor). In addition, it is preferable that a determination as to from which document a print image is rendered when the print image is rendered by the image rendering part be made from documents of higher significance that have been determined by the significance determination part. Here, note that in case where a personal computer with a screen saver built therein is used as the electronic document management apparatus 30, the detection of an idle state of the computer by the idle detection part 710 can be made by detecting the activation of the screen saver.

Moreover, it is also preferable that the respective parts (401-406 and 410-412) and (701-706 and 710-712) of the electronic document management apparatuses 10, 30 in FIG. 1 and FIG. 7, respectively, be shared or commonalized, and that a group of the print instruction part 407, the print management part 408 and the printing part 409, and a group of the display instruction part 707, the display management part 708 and the display part 709 be selectively operated.

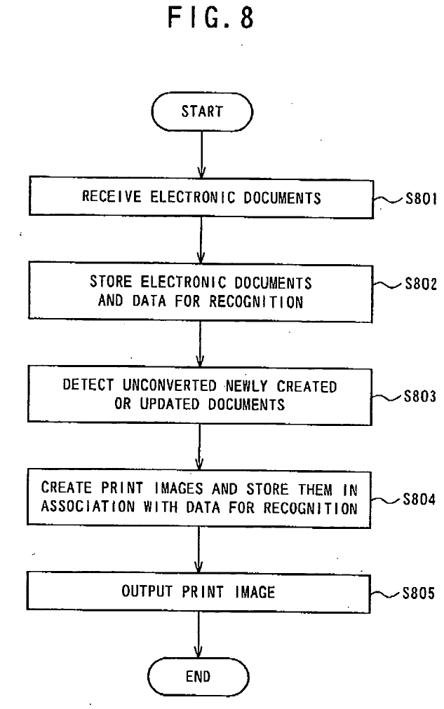

FIG. 8 is a flow chart that explains the overall flow of processing in the document management apparatus according to this embodiment.

First of all, electronic documents from a higher order device are received (S801).

Then, the electronic documents and the data for recognition, from which the features of the electronic documents can be recognized, are stored (S802).

Newly created or updated electronic documents that have not been subjected to bitmap conversion processing after storage thereof are detected from among the stored electronic documents at each electronic document processing timing (S803).

Bitmapped print images for the newly created or updated electronic documents thus detected are rendered, and then stored in association with the data for recognition of the above-mentioned electronic documents (S804). That is, prior to the occurrence of an output request for the electronic documents, they are converted in advance into bitmapped print images, which are then stored. At this time, the level of significance of each electronic document may be determined, so that only the electronic documents with their levels of significance being higher than or equal to a predetermined level of significance can be converted.

When an output request for an electronic document is made based on the data for recognition, a print image corresponding to the requested electronic document is selected from among the print images stored (S805). That is, when an electronic document is requested to be output, the above-mentioned converted and stored print image corresponding to the requested electronic document is output.

Here, note that the respective steps in the processing of the file management apparatus according to this embodiment are achieved by making an unillustrated control section execute a document management program stored in an unillustrated storage section.

Although in this embodiment, functions for realizing the present invention are recorded beforehand in the interior of the apparatus, the present invention is not limited to this but similar functions can be downloaded into the apparatus via a network, or a computer-readable recording medium storing therein similar functions can be installed in the apparatus. Such a recording medium can be of any form, such as for example a CD-ROM, which is able to store programs, and which is able to be read out by the apparatus, In addition, the functions to be obtained by such preinstallation or downloading can be achieved through cooperation with an OS (operating system) or the like in the interior of the apparatus,

Although in the foregoing, the present invention has been explained through a variety of embodiments, such an explanation is not intended to limit the invention to these embodiments, but instead, the present invention includes all alternatives, changes and equivalents thereof included within the spirit and scope of the invention defined by the appended claims.

As described in detail above, according to the present invention, an electronic document management program of the present invention serves to convert in advance electronic documents into bitmapped print images and store them prior to the occurrence of an output request for the electronic documents, so that when an electronic document is requested to be output, a corresponding previously converted and stored print image is output. As a result, at the time of such an electronic document output request, it is not necessary to perform conversion of the document into its print image, so the request can be responded to at once. In addition, if the electronic document is stored through conversion into the print image during an idle state of the apparatus, such work can be done more efficiently.

What is claimed is:

1. An electronic document management program comprising:
a step of converting in advance electronic documents into bitmapped print images and storing them prior to the occurrence of an output request for the electronic documents; and
a step of outputting, upon an electronic document being requested to be output, that one of said converted and stored print images which corresponds to the electronic document thus requested.

2. The electronic document management program according to claim 1, further comprising:
a step of determining a level of significance of each electronic document and converting into print images only those electronic documents which have levels of significance higher than or equal to a predetermined level of significance.

3. The electronic document management program according to claim 1, further comprising:
a step of determining, when a storage capacity necessary for print images to be newly stored is insufficient, the level of significance of each electronic document and deleting from storage the print images of the electronic documents in the order of lowest to highest level of significance so as to secure a necessary storage capacity.

4. An electronic document management program comprising:
a step of storing electronic documents from a higher order device;
a step of storing data for recognition, from which said stored electronic documents and their features can be recognized, respectively;
a step of detecting newly created or updated electronic documents that have not been subjected to bitmap conversion processing after storage thereof from among said stored electronic documents at each electronic document processing timing;
a step of creating bitmapped print images for said newly created or updated electronic documents thus detected, and storing said print images thus rendered in association with the data for recognition of said electronic documents; and
a step of selecting and outputting, when an output request for an electronic document is made based on said data for recognition, a print image corresponding to said requested electronic document from among said print images stored.

5. The electronic document management program according to claim 4, wherein said electronic document processing timing is when said higher order device is in an idle state in which a screen saver is operated.

6. The electronic document management program according to claim 4, wherein in a step where said electronic documents are converted into print images, the level of significance of each electronic document is determined, and the step of conversion is executed only on electronic documents with their levels of significance being higher than or equal to a predetermined level of significance, whereas when an electronic document not yet converted into a print image is requested to be output, it is converted into its print image at that time.

7. The electronic document management program according to claim 4, further comprising:
a step of determining, when a storage capacity necessary for print images to be newly stored is insufficient, the level of significance of each electronic document and deleting from storage the print images of the electronic documents in the order of lowest to highest level of significance so as to secure a necessary storage capacity.

8. An electronic document management apparatus comprising:
a document storage part that stores electronic documents from a higher order device;
an update detection part that detects newly created or updated electronic documents which have not been subjected to bitmap conversion processing after storage thereof from among said electronic documents stored in said document storage part at each electronic document processing timing;
a print image rendering part that converts said electronic documents into bitmapped print images;
an image storage part;
a document management part that manages each of said electronic documents stored in said document storage part and data for recognition, from which the feature of each of said electronic documents can be recognized, makes, upon detection of the newly created or updated electronic documents by said update detection part, said print image rendering part create print images of said electronic documents thus detected, and stores said print images thus rendered in said image storage part in association with said data for recognition of said electronic documents detected by said update detection part; and
a print image output part that reads and outputs, upon occurrence of an output request for an electronic document based on said data for recognition, a print image corresponding to said data for recognition of said electronic document requested to be output from said image storage part.

9. The electronic document management apparatus according to claim 8, wherein said electronic document processing timing is when said higher order device is in an idle state in which a screen saver is operated.

10. The electronic document management apparatus according to claim 8, wherein said print image output part comprises:
a print instruction part that receives an output request for designating and printing an electronic document; and
a print management part that cooperates with said document management part to read, based on the output request received by said print instruction part, a print image corresponding to the electronic document thus designated from said image storage part, and to deliver the print image thus read to a printing part for printing thereof.

11. The electronic document management apparatus according to claim 8, wherein said print image output part comprises:
a display instruction part that receives an output request for designating and displaying an electronic document; and
a display management part that cooperates with said document management part to read, based on the output request received by said display instruction part, a print image corresponding to said electronic document thus designated from said image storage part, and to deliver said print image thus read to a display part for displaying thereof.

12. The electronic document management apparatus according to claim 8, wherein when a transmission part receives an output request for designating and transmitting an electronic document, said print image output part cooperates with the document management part to read a print image corresponding to said designated electronic document from said image storage part, and to transmit said print image thus read.

13. The electronic document management apparatus according to claim 12, wherein said transmission part transmits said print image in a manner such that mobile equipment can receive and print or display said print image.
